(19) United States
(12) Patent Application Publication
(10) Pub. No.: US 2008/0007610 A1
(43) Pub. Date: Jan. 10, 2008

(54) Heat Developing Apparatus and Heat Developing Method

(76) Inventors: Suguru Kamio, Tokyo (JP); Mamoru Umeki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/794,159

(22) PCT Filed: Dec. 21, 2005
(86) PCT No.: PCT/JP05/23457

§ 371 Date: Jun. 25, 2007

(30) Foreign Application Priority Data
Dec. 28, 2004 (JP) 2004-379316
Jan. 26, 2005 (JP) 2005-018099
Feb. 8, 2005 (JP) 2005-031684

(51) Int. Cl. B41J 2/32

(52) U.S. Cl. 347/171

(57) ABSTRACT

A heat developing system and a heat developing method in which occurrence of uneven density due to creasing of a sheet film can be suppressed even if quick processing is performed with heating time of 10 sec. or shorter. The heat developing system includes a means for heating the sheet film in a predetermined heating region, and plural opposing rollers arranged oppositely to the heating means and carrying the sheet film while pressing in conjugation with the heating means, wherein the heating time of the sheet film by the heating means is 10 sec. or shorter, and arrangement of the opposing rollers in the heating region corresponding to a temperature range from the glass transition point of a supporting substrate of the sheet film to a predetermined temperature is different from that in other heating regions.

### TECHNOLOGICAL FIELD

This invention relates to a heat developing apparatus and heat developing method in which a latent image is formed on a sheet film where a heat developing photosensitive material has been applied to one side of a supporting substrate and then the sheet film is heated.

### BACKGROUND TECHNOLOGY

In the prior art, heat developing apparatuses and heat developing methods are known in which latent images formed by irradiating a laser beam on a film comprising a heat developing photosensitive material are heated and thereby developed (see patent documents 1 to 3). In this heat development process, when the film is continuously heated to a temperature that is above the glass transition point, the film expands and begins to soften and also attempts to deform. If the heating zone (temperature raising region) of the film is substantially straight (see Patent Document 1 below for example), irregular three-dimensional bending of the film that is being conveyed occurs due to this deformation and uneven contact with the heating plate occurs which makes it likely for irregular non-directional density unevenness (heating unevenness) to occur. Furthermore, because the bending attempts to enlarge instantaneously as the film is entered into the roller nip for film conveyance, the foregoing unevenness is promoted.

Meanwhile, in the substantially arc-shaped curved conveyance system of Patent Document 3 below, due to the curved shape of the conveyance direction, it is possible to control the bending such that it has a regular configuration, but large curvature causes the apparatus to become bulky.

In addition, if the time for increasing the film temperature can be set to be long, sudden temperature changes in the film do not occur and thus occurrence of the crease can be controlled, but the time for the hard copy is extended, and this is not favorable for medical images in view of speedy diagnosis. In the prior art heat developing apparatus, the heat developing time is generally about 14 seconds (for a conveyance direction length of 17 inches), but when the heat developing process is required to be quick in view of the foregoing speedy diagnosis, and the time for increasing the film temperature is set to be short, density unevenness due to the occurrence of creasing becomes problematic.

In addition, Patent Document 4 below, an image forming apparatus is disclosed in which a plurality of press rollers and pressing means for pressing the expanded portion of the heat developing photosensitive material caused by heating at the time of development are arranged so as to oppose each other along one surface of the plate heater. However, further improvement at the time of quick processing in particular, is desired. Patent Documents 1-4 do not indicate or disclose measures for handling problems associated with a speedy heat developing process.

Patent Document 1: Unexamined Japanese Patent Application Publication No. 2000-330252

Patent Document 2: Unexamined Japanese Patent Application Publication No. 2000-284459

Patent Document 3: Unexamined Japanese Patent Application Publication No. 2003-287862

Patent Document 4: Unexamined Japanese Patent Application Publication No. Hei 11-352660

### DISCLOSURES OF THE INVENTION

### Problems to be Solved by the Invention

In view of the foregoing problems of the prior art, an object of this invention is to provide a heat developing apparatus and a heat developing method in which occurrence of uneven density due to crease of the film can be suppressed even if quick processing is performed within a heating time of 10 seconds or less.

### Means to Solve the Problems

In order to achieve the foregoing objective, the heat developing apparatus of this invention includes a heating means for heating sheet film at a predetermined heating region after latent image has been formed on a sheet film where a heat developing photosensitive material was applied to one side of a supporting substrate, and a plurality of opposing rollers arranged so as to oppose the heating means and which presses the sheet film and works with heating means to convey the sheet film, wherein the heating time of the sheet film by the heating means is 10 seconds or less, and the arrangement of the opposing rollers in the heating region which corresponds to a temperature range from the glass transition point of the supporting substrate of the sheet film to a predetermined temperature is different from that in other heating regions.

The preferable embodiments of the opposing rollers whose arrangement is different from that in other heating regions are as follows.

1) A plurality of opposing rollers in the heating region, which corresponds to a temperature range from the glass transition point of the supporting substrate of the sheet film to a predetermined temperature, are arranged more closely in the conveyance direction of the sheet film than that in the other heating regions (which is a first embodiment of the heat developing apparatus).

2) The opposing rollers in the heating region, which corresponds to a temperature range from the glass transition point of the supporting substrate of the sheet film to a predetermined temperature, are arranged to be inclined at a predetermined angle with respect to the conveyance direction of the sheet film (which is a second embodiment of the heat developing apparatus).

According to the developing apparatus of the first embodiment, because the heating time of the sheet film is 10 seconds or less for quick processing, and because the time for increasing the temperature to the heat developing temperature of the sheet film is limited, the sheet film tends to bend three-dimensionally due to sudden heat change in the temperature range from the glass transition point of the supporting substrate of the sheet film to the predetermined temperature, and conveyance of the sheet film is continued in that state, the contact state with the heating means (state of heat transfer from the heating means) becomes uneven along the entire surface of the film. However, by arranging the opposing rollers in the conveyance direction of the sheet film more closely in the heating region of said temperature range than in the other heating regions, the crease caused by expansion of the support of the film can be corrected to be substantially flat by the plurality of closely arranged opposing rollers. After stretching out the crease by the above manner, and continuing conveyance of the sheet film whose creasing has been stretched out, uniform contact heating in the heating means along the entire film surface becomes possible. In this manner, when quick processing is performed in which the heating time of the sheet film is 10 seconds or less, occurrence of uneven contact and heat transfer unevenness due to distortion and crease caused by expansion of the support can be suppressed and the occurrence of density unevenness is thereby controlled.

In addition, the closely arranged opposing rollers preferably have a predetermined gap with respect to the heating means. As a result, when the sheet film is entered into each opposing rollers, the impact can be reduced and occurrence of three-dimensional bending of the sheet film can be prevented.

Also, the opposing rollers that are arranged at least just before the closely arranged opposing rollers preferably have a configuration in which the diameter of the center portion is thick while that of the end portions is thin. In this case, the opposing rollers that have been closely arranged are preferably straight rollers having the constant diameter. As a result, the sheet film tends to be expanded horizontally from the center and attempts to stretch out (attempts to bend), and a lift off amount (amount of convexity due to bending) becomes small, and thus the three-dimensional bending direction and/or bending amount of the sheet film due to sudden heat change can be controlled and the occurrence of crease is controlled.

According to the second embodiment, because the heating time of the sheet film for quick processing is 10 seconds or less, and because the time for raising the temperature to the heat developing temperature of the sheet film is limited, the sheet film tends to bend three-dimensionally due to sudden heat change in the temperature range from the glass transition point of the support for sheet film to the predetermined temperature, and conveyance of the sheet film is continued in that state, the contact state with the heating means (state of heat transfer from the heating means to the sheet film) becomes uneven along the entire surface of the film. However, by arranging the heating roller to be inclined at a predetermined angle with respect to the conveyance direction of the sheet film in the heating region of the temperature range, the three-dimensional crease and distortion caused by expansion of the support can be corrected to be substantially flat by pulling the film to one side using the plurality of inclined opposing rollers. After stretching out the crease by continuing conveyance of the sheet film whose crease has been stretched out, uniform contact heating in the heating means along the entire film surface becomes possible. In addition, because the opposing rollers are inclined with respect to the conveyance direction, and because the film is gradually entered from one side edge of the leading edge, when the film is entered into the opposing rollers, the entry impact is reduced and occurrence of creasing due to this entry impact can be suppressed. In this manner, when quick processing is performed in which the heating time of the sheet film is 10 seconds or less, occurrence of contact and heat transfer unevenness due to distortion and crease caused by heat change of the support can be suppressed, and the occurrence of density unevenness is thereby controlled.

In addition, it is preferable that the incline direction of the opposing rollers in the heating region is different with respect to the opposing rollers of the upstream side and/or the adjacent downstream side. By arranging the plurality of opposing rollers by changing the incline direction with respect to each other, three-dimensional creasing and distortion can be effectively stretched out, and corrected to be substantially flat. The creasing direction and amount of expansion of the sheet film vary due to the spread direction of the support formed of PET or the like, which is cut in a sheet to have a predetermined configuration in terms of length and width, but the crease can be effectively stretched out and controlled regardless of the spread direction in which the film is cut.

In addition, the opposing rollers that are arranged at least just before the inclined opposing rollers preferably have a configuration in which the diameter of the center portion is large while the end portion is small. Due to this configuration, the sheet film tends to be expanded horizontally from the center and attempts to spread (attempts to bend), and thus the lift off amount (amount of convexity due to bending) becomes small, and thus the three-dimensional bending direction and bending amount of the sheet film due to its sudden expansion can be controlled and furthermore, pulling of the film in one direction by the opposing rollers 12a, that are inclined in the downstream conveyance direction H, becomes more effective, and more horizontal spread of the crease from the opposing roller center occurs and the amount of creasing generated is suppressed.

The heating means in the heat developing apparatus of the present invention preferably includes a temperature raising section for increasing the temperature of the sheet film to the heat developing temperature, and a temperature retaining section for maintaining the temperature of the sheet film whose temperature was increased to the heat developing temperature. In the temperature retaining section, contact heating like that done in the temperature raising section is not necessary, and thus the opposing rollers can be omitted and thus the number of parts can be reduced and a decrease in cost can be realized.

It is preferable that the heating time for the sheet film in the heating section is 4 second or less for quick processing.

In order to achieve the foregoing object, the heat developing method includes:

a step of forming a latent image on a sheet film where a heat developing photosensitive material has been applied to one side of a supporting substrate,

a step of conveying the sheet film carrying the latent image in a predetermined heating region while pressing the sheet film using a plurality of opposing rollers arranged in a heating region, while heating the sheet film such that the heating time for the sheet film is 10 seconds or less, and

a step of heating the sheet film in a temperature range from the glass transition point of a supporting substrate of the sheet film to a predetermined temperature, in a heating region in which the arrangement of the opposing rollers in the conveyance direction of the sheet film is different from that in other heating regions.

Preferable embodiments of the heat developing method of the present invention are as follows.

1) When the sheet film is conveyed, heating is conducted in the temperature range from the glass transition point of the supporting substrate of the sheet film to a predetermined temperature in the heat region in which the plurality of opposing rollers are arranged more closely in the conveyance direction of the sheet film than that in the other heating regions (first embodiment of the heat developing method).

2) When the sheet film is conveyed, heating is done in a temperature range from the glass transition point to a predetermined temperature of the supporting substrate of the sheet film in a heating region in which the opposing rollers are arranged to be inclined at a predetermined angle with respect to the conveyance direction of the sheet film (second embodiment of the heat developing method).

According to the heat developing method of the first embodiment of this invention, because the heating time of the sheet film for quick processing is 10 seconds or less, and because the time for raising the temperature to the heat developing temperature of the sheet film is limited, the sheet film tends to bend three-dimensionally due to sudden heat expansion in the temperature range from the glass transition point of the support for sheet film to a predetermined temperature, and if conveyance of the sheet film is continued in that state, the contact state with the heating plate (state of heat transfer from the heating plate) becomes uneven along the entire surface of the film. However, creasing caused by expansion of the support can be corrected to be substantially flat by the plurality of opposing rollers arranged more closely than in the other heating regions. After stretching out the crease due to correction, by continuing conveyance of the sheet film whose crease has been stretched out, uniform contact heating on the heating plate along the entire film surface becomes possible. In this manner, when quick processing is performed in which the heating time of the sheet film is 10 seconds or less, occurrence of contact and heat transfer unevenness due to distortion and creasing caused by expansion of the support can be suppressed, and the occurrence of density unevenness on the developed film is thereby controlled.

The heating region in which the plurality of opposing rollers are arranged more closely than in other heating region is included in the heating region for performing the temperature raising process.

According to the heat developing method of the second embodiment, because the heating time of the sheet film for quick processing is 10 seconds or less, and because the time for raising the temperature to the heat developing temperature of the sheet film is limited, the sheet film tends to bend three-dimensionally due to sudden expansion by heating in the temperature range from the glass transition point of the support of the sheet film to a predetermined temperature, and if conveyance of the sheet film is continued in that state, the contact state with the heating plate (state of heat transfer from the heating plate) becomes uneven along the entire surface of the film. However, because the heating rollers are arranged to be inclined at a predetermined angle with respect to the conveyance direction of the sheet film in the heating region of the temperature range, the three-dimensional creasing and distortion caused by expansion of the support can be stretched out by pulling the film to one side using the inclined opposing rollers and corrected to be substantially flat. After stretching out the crease due to the correction, by continuing conveyance of the sheet film whose crease has been stretched out, uniform contact heating in the heating plate along the entire film surface becomes possible. In addition, because the opposing rollers are inclined with respect to the conveyance direction, and because the film gradually enters from the end, when the film is to enter the opposing rollers, the entry impact is lessened and occurrence of creasing due to this entry impact can be suppressed. In this manner, when quick processing is performed in which the heating time of the sheet film is 10 seconds or less, occurrence of contact and heat transfer unevenness due to distortion and creasing caused by heat change of the support can be suppressed, and the occurrence of density unevenness is thereby controlled.

In the heat developing method of the present invention, heating of the sheet film is preferably performed in the temperature raising step for increasing the temperature of the sheet film to the heat developing temperature, and in a temperature retaining step for maintaining the temperature of the sheet film whose temperature was increased to the heat developing temperature.

In addition, it is preferable that the heating time for the sheet film in the temperature raising step is 4 second or less for quick processing.

### EFFECTS OF THE INVENTION

According to the heat developing apparatus and heat developing method of the present invention, even when quick processing with a heating time of 10 seconds or less is performed, it is possible to suppress occurrence of density unevenness due to the occurrence of film creasing.

### BRIEF DESCRIPTION OF THE DRAWINGS

FIG. 1 is a side view which schematically shows the main parts of the heat developing apparatus of this invention.

FIG. 2 is a front view which schematically shows a roller configured with a center convexity that is arranged in the temperature raising section of FIG. 1.

FIG. 3 is a plan view which schematically shows the plurality of opposing rollers arranged in the temperature raising section of FIG. 1.

FIG. 4 shows the plurality of slitter positions for cutting the film from the original roll (whole roll) in which heat developing photosensitive material has been applied to a wider PET base roll.

FIG. 5 shows positions of the opposing rollers arranged with respect to each of the heating plates in Working examples 1, 2, and 3 and References 1, 2, 3.

FIG. 6 is a side view which schematically shows the plurality of heating plates and the opposing rollers that are arranged with respect to the heating plates in Working Example 4 and Reference 4.

FIG. 7 is a side view which schematically shows the main parts of the developing apparatus used in the heat developing method of the third embodiment.

FIG. 8 shows the temperature profile of the heat developing process in the heat developing method of the third embodiment used in the heat developing apparatus of FIG. 7.

FIG. 9 shows the temperature profile of the heat developing process in another heat developing method of the heat developing method of the third embodiment used in the heat developing apparatus of FIG. 7.

FIG. 10 is a side view which schematically shows the arrangement of the heating plates of the heat developing apparatus used in a referential example and the reference.

FIG. 11 shows the increased temperature curves for the films in References 5 and 6.

FIG. 12 shows a modified example (in which the second heating zone of the temperature raising section is a conveyance path with a curved surface configuration) of the temperature raising section in the heat developing apparatus of FIG. 7.

### EXPLANATION OF LEGEND

1 Heat developing apparatus
10 Temperature raising section
11 First heating zone
11a, 11c Opposing rollers
11b Heating guide
11c Heater
11d Fixed guide surface
11f Center portion
11g, 11h End portion
12 Second heating zone
12a Plurality of opposing rollers
12b Heating guide
12c Heater
12d Fixed guide surface
13 Temperature retaining section
13a Guide section
13b Heating guide
13c Heater
13d Fixed guide surface
14 Cooling section of sheet film F
15 Optical scanning exposure section
H Film conveyance direction
d Gap

### PREFERRED EMBODIMENTS OF THE INVENTION

The following is a description of the preferred embodiments of this invention with reference to the drawings. It is to be noted that in the following description, unless otherwise specified, no distinction is made between the parts which are the same in the heat developing apparatus of the first embodiment and the heat developing apparatus of the second embodiment.

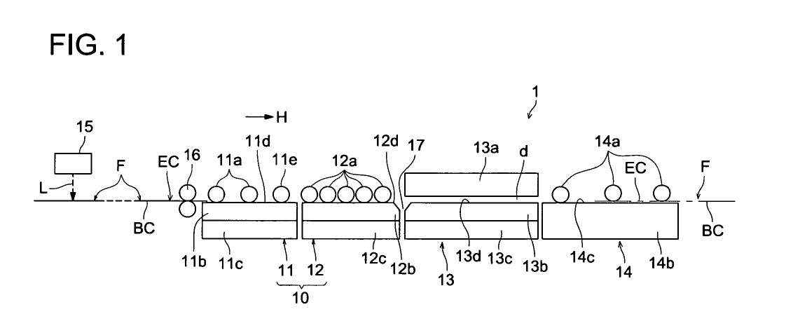

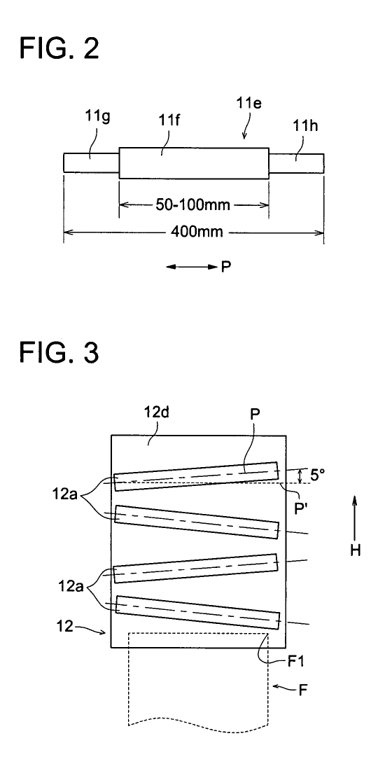

FIG. 1 is a side view which schematically shows the main parts of the heat developing apparatus of this invention. FIG. 2 is a front view which schematically shows a roller configured with a center convexity that is arranged in the temperature raising section of FIG. 1. FIG. 3 is a plan view which schematically shows the plurality of opposing rollers (for the heat developing apparatus of the second embodiment) arranged in the temperature raising section of FIG. 1.

As shown in FIG. 1, the heat developing apparatus 1 of this invention is one which forms latent images on the EC surface of a sheet film F (called “film F” hereinafter) by performing secondary scanning and conveyance of the sheet film F in the conveyance direction H while exposing film F by scanning with the laser beam L in the scanning and exposure section 15 based on image data. The sheet film F includes the EC surface where a heat developing photosensitive material is applied on one surface of a sheet-like supporting substrate formed of PET (polyethylene terephthalate) or the like and a BC surface which is at the side of the supporting substrate opposite to the EC surface. Next the film F is developed by being heated from the BC surface side and the latent images become visible.

The heat developing apparatus of FIG. 1 includes a temperature raising section 10 for heating the film F on which latent images have been formed, from the BC surface side, and increases the temperature to a predetermined heat developing temperature; a temperature retaining section 13 for maintaining the temperature of the sheet film F at the predetermined heat developing temperature; and a cooling section 14 for cooling the heated film F, from the BC surface side. The heating section includes the temperature raising section 10 and the temperature retaining section 13, and it heats the film F to the heat developing temperature, and maintains the heat developing temperature.

The temperature raising section 10 includes a first heating zone 11 which heats the film F at the upstream side of the conveyance direction H and a second heating zone 12 which heats at the downstream side.

The first heating zone includes a flat heating guide 11b that is made from a metal material such as aluminum and the like and is fixed; a flat heater 11c that is formed from a silicone rubber heater or the like that is tightly adhered to the back surface of the heating guide 11b; and a plurality of opposing rollers 11a and 11e which are arranged so as to maintain a space that is narrower than the thickness of film so that it is possible to press the film onto the fixed guide surface 11d of the heating guide 11b and the surfaces are made of silicone rubber or the like which has more insulation properties than metal and the like.

The second heating zone includes a flat heating guide 12b that is made from a metal material such as aluminum and the like and is fixed; a flat heater 12c that is formed from a silicone rubber heater or the like that is tightly adhered to the back surface of the heating guide 12b; and a plurality of opposing roller 12a which are arranged so as to maintain a gap that is narrower than the thickness of film so that it is possible to press the film onto the fixed guide surface 12d of the heating guide 12b and the front surface is made of silicone rubber or the like which has more insulation properties than metal and the like.

The plurality of opposing rollers 12a of the second heating zone 12 are straight rollers having the constant diameter in the axial direction P (see FIG. 2). In addition, as shown in FIG. 2, the opposing rollers 11e that are furthest downstream from the first heating zone 11 (just before the upstream side of the opposing roller 12a of the second heating zone 12) include a large diameter center portion 11f that is arranged at the center portion in the axial direction P thereof and small diameter ends 11g and 11h that are arranged at both ends and this forms the roller with the center convexity. The length in the axial direction P of opposing roller 11e is 400 mm for example and the length of the center portion 11f is preferably 50 to 100 mm, and the radius of the center portion 11f is preferably 50 to 200 μm larger than the end portions 11g and 11h. It is to be noted that the other opposing rollers 11a of the first heating zone 11 are formed of straight rollers, but which are possible to be the same structure as the opposing rollers 11e.

In the heat developing apparatus of the first embodiment, the plurality of the opposing rollers 12a in the second heating zone 12 are more closely arranged in the conveyance direction H of the film F than the plurality of the opposing rollers 11a and 11e in the first heating zone 11.

As shown in FIG. 3, in the heat developing apparatus of the second embodiment, the plurality of opposing rollers 12a of the second heating zone 12 are formed of straight rollers having the constant diameter in the axial direction P thereof and they are arranged so as to be inclined in the conveyance direction H of the film. Each opposing roller 12a is arranged such that the angle to the orthogonal line P′ where the axis direction P and the conveyance direction H are at right angles to each other is 5 degrees. The opposing rollers 12a are arranged by changing the incline direction with respect to each other and the incline direction of each opposing roller 12a is different from the adjacent opposing roller 12a.

The temperature retaining section 13 includes a flat heating guide 13b that is made from a metal material such as aluminum and the like and is fixed; a flat heater 13c that is formed from a silicone rubber heater or the like that is tightly adhered to the back surface of the heating guide 13b; and a guide section 13a that is formed from heat insulating material that is arranged so as to oppose the fixed guide surface 13d that is formed on the front surface of the heating guide 13b with a predetermined space (gap) “d” between them.

In the first heating zone 11 of the temperature raising section 10, the film F, that is conveyed from the upstream side of the temperature raising section 10 by the conveyance roller pair 16, is pressed to the fixed guide surface 11d by the opposing rollers 11a that are rotated to be driven and as a result, the BC surface comes in close contact with the fixed guide surface 11d and is heated while being conveyed in the conveyance direction H.

Similarly in the second heating zone 12, the film F that is conveyed from the first heating zone 11 is pressed to the fixed guide surface 12d by the opposing rollers 12a that are rotated to be driven and as a result, the BC surface comes in close contact with the fixed guide surface 11d and is heated while being conveyed in the conveyance direction H. At the time of this conveyance, as shown in FIG. 3, in the heat developing apparatus of the second embodiment, the opposing rollers 12a are inclined at a predetermined angle with respect to the conveyance direction H of the film F and it is thus conveyed by pulling one side. Even if three-dimensional creasing or distortion occurs on the film, they can be corrected to be substantially flat by stretching out the creases and the distortion.

There is an open concave portion 17 which is V-shaped between the second heating zone 12 of the temperature raising section 10 and the temperature retaining section 13, and any foreign material from the temperature raising section 10 falls into the concave portion 17. As a result, foreign matter from the temperature raising section 10 is prevented from being taken into the temperature retaining section 13 and generation of jams, scratches, and density unevenness on the film is prevented.

In the temperature retaining section 13, the film F that is conveyed from the second heating zone 12 is heated (kept hot) with heat from the heating guide 13b in the space “d” between the fixed guide surface 13d and the guide section 13a of the heating guide 13b while passing through the gap “d” due to the conveyance force of the opposing rollers 12a at the second heating zone side.

In the cooling section 14, the film is brought in contact with the cooling guide surface 14c of the cooling plate 14b that is formed of a metal material or the like and it is further conveyed in the conveyance direction H by the opposing rollers 14a while being cooled. It is to be noted that the cooling effect can be increased by forming the cooling plate 14b as a heat sink with fins. A cooling plate that is formed as a heat sink with fins may also be placed at the downstream side of the cooling plate 14b.

As described above, in the heat developing apparatus of FIG. 1, in the temperature raising section 10 and the temperature retaining section 13, the BC surface of the film F faces the fixed guide surfaces 11d, 12d, and 13d in the heated state and the EC surface on which a heat developing photosensitive material has been applied is conveyed to be open to an ambient atmosphere. In addition, in the cooling section 14, as shown by the dotted chain line, the BC surface of the film F is brought in contact with cooling guide surface 14c and cooled, and the EC surface on which a heat developing photosensitive material has been applied is conveyed open to an ambient atmosphere.

The film F is conveyed by the opposing rollers 11a and 12a such that the time for passing the temperature raising section 10 and the temperature retaining section 13 is 10 seconds or less. Thus, the heating time from temperature increase to temperature retaining must also be 10 seconds or less. In addition, the film F is conveyed by opposing rollers 11a and 12a such that the time for passing the temperature raising section 10 is 4 seconds or less and heating time for increasing the temperature is 4 seconds or less.

The second heating zone 12 of the temperature raising section 10 forms a heating region in which it is possible to heat the film, from a temperature (73° C. for example) that is less than the glass transition point of PET which is the support, to the heat developing temperature (123° C. for example), and the film F is heated to the developing temperature in the second heating zone 12.

When the film F is heated relatively rapidly such that the heating time for temperature raising is 4 seconds or less, the crease tends to occur in the temperature range from the glass transition point (73° C. for example) of PET which is the support to the predetermined temperature (115° C. for example) that is less than the heat developing temperature (123° C. for example). Heating of the film F in this temperature range in which creasing tends to occur is performed in the second heating zone 12 which has the plurality of rollers 12a that are closely arranged in the conveyance direction H.

The temperature raising section 10 in FIG. 1 includes the first and second heating zones 11 and 12, and the number of heating zones may be increased, or the heating zones may be divided, but in the heat developing apparatus of the first embodiment, heating of the film F in the temperature range in which creasing tends to occur is performed in the heating region in which the opposing rollers are closely arranged in the conveyance direction H. In addition, in the heat developing apparatus of the second embodiment, heating of the film F in the temperature range in which creasing tends to occur is performed in the heating region in which the opposing rollers are arranged to incline with respect to the conveyance direction H.

As described above, the film F is heated such that the heating time in the heating section which includes the temperature raising section 10 and the temperature retaining section 13 is 10 seconds or less, and the heating time in the temperature raising section 10 is 4 seconds or less. Because the time for increasing the temperature to the heat developing temperature (123° C. for example) is limited and the heating is done comparatively rapidly, the film F attempts to bend three-dimensionally due to sudden expansion of the PET due to heating in the temperature range (73° C. to 115° C. for example) from the glass transition point of the support (PET) of the film F to a predetermined temperature. In addition, if conveyance of the film F continues as it is, the contact state with the heating guide 12b or in other words, the state of heat transfer from the heating guide 12b is no longer uniform along the entire film surface. However,

1) according to the heat developing apparatus of the first embodiment, creasing caused by expansion of the PET generated during passage in the foregoing temperature range can be corrected to be substantially flat (stretching out the creases) using the closely arranged opposing rollers 12a and by subsequently continuing conveyance of the film F uniform contact heating by the heating guide 12b along the entire film surface becomes possible; and

2) according to the heat developing apparatus of the second embodiment, creasing caused by expansion of the PET generated during passage in the foregoing temperature range can be corrected to be substantially flat (stretching out the creases) with the plurality of opposing rollers 12a arranged so as to incline with respect to the conveyance direction H and by subsequently continuing conveyance of the film F uniform contact heating by the heating guide 12d along the entire film surface becomes possible. As a result, distortion→creasing→contact unevenness→heat transfer unevenness→density unevenness, caused by expansion of the PET due to heating can be suppressed, and stable density can be obtained within a single heating time.

In the prior art, expansion of the film that is heated is restricted by opposing rollers in the temperature range where creasing occurs easily (movement is not possible due to the effect of the nip pressure of the opposing rollers at least in the axial direction), and when spring pressure acts on the left and right ends of the opposing rollers, the film tends to become convex on the other hand, at the portion where the opposing rollers are not present, it tends to extend freely (and sometimes surge). This extending is not uniform since it is also affected by the spread direction at the time of manufacturing of the PET base and by conveying the film and then restricting again in the same manner using the next opposing roller, a difference in heat transfer is generated between the portion that is in contact with the heating guide and the portion that is not in contact with the heating guide, and this causes density unevenness and in order to deal with this:

1) in the heat developing apparatus of the first embodiment, the bending (creasing) of the film F is corrected by the plurality of opposing rollers 12a that have been closely arranged and the film F is shaped so as to be substantially flat, and by carrying out the shaping early in the time for the heating process, in the limited remaining time, the entire surface of the film can be evenly heated and more stable density can be obtained; and

2) in the heat developing apparatus of the second embodiment, the bending (creasing) of the film F is corrected by the plurality of opposing rollers 12a that have been arranged so as to incline and the film F is shaped so as to be substantially flat, and by carrying out the shaping early in the time for the heating process, in the limited remaining time, the entire surface of the film can be evenly heated and more stable density can be obtained.

In addition, because the plurality of opposing rollers 12a have a predetermined gap with respect to the fixed guide surface 12d of the heating guide 12b, the impact when the film F is entered into opposing rollers 12a can be lessened and the occurrence of three-dimensional swelling can be prevented.

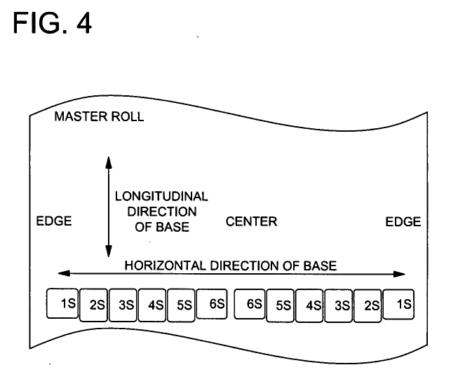

Stretching out due to heat change of the film is affected by the spread direction at the time of manufacturing of the PET base which is the support, and the difference in the amount of heat expansion due to the spread direction of the PET will be described with reference to FIG. 4.

FIG. 4 shows the plurality of slitter positions (1S-6S respectively from the left end to the right end and the position of each slitter 1S-6S corresponds to cutting position of the film) for cutting the film from a roll (whole roll) in which heat developing photosensitive material is applied to the wider PET base in the present invention.

As shown in FIG. 4, in each of the films cut by each of the slitters 1S-6S, the longitudinal direction and the horizontal direction of the film are different from the base longitudinal direction and the base width direction of the original roll and the film cutting direction is different for each slitter. For example, when the film that is cut by the slitters 1S and 6S is compared with the film that is cut with separate slitters 2S-5S, the film cutting directions are different and thus the spread direction is different at the time of molding of the PET base. In the PET base, because the heat expansion coefficient due to the spread direction is different, the amount of stretching out of the film due to heat expansion resulting from the positions of the various slitters (cutting position) becomes different.

As is the case in the heat developing apparatus of the second embodiment, by arranging the plurality of opposing rollers 12a in the second heating zone 12 by changing the incline direction with respect to each other, three-dimensional creasing and distortion can be effectively stretched out, and thus as shown in FIG. 4, creasing can be effectively stretched out and corrected regardless of the spread direction in which the film is cut.

In addition, when the film F is entered into the opposing rollers 12a of the second heating zone 12, the opposing rollers 12a are inclined with respect to the conveyance direction H, and as shown by the broken line in FIG. 3, the film F is gradually entered from the right end F1 for example and thus the entry impact is lessened and occurrence of creasing due to entry impact is suppressed.

The opposing rollers 11e that are arranged immediately before the upstream side of the opposing rollers 12a preferably have a configuration in which the axial direction P center portion 11f is thick and end portions 11g and 11h are thin. Also because the plurality of opposing rollers 12a are straight rollers having the constant diameter in the axial direction, the sheet film F is distributed horizontally from the center portion 11f and attempts to stretch out (attempts to bend), and so the lift off amount (amount of convexity due to bending) becomes small, and the three-dimensional bending direction and/or bending amount of the film F due to sudden heat change can be controlled and the occurrence of creasing is suppressed and thus this is favorable.

In addition, the heat developing apparatus of the second embodiment, pulling of the film F in one direction by the opposing rollers 12a that are inclined in the downstream conveyance direction H becomes more effective and the amount of creasing generated is suppressed, and thus this is favorable.

The effects of this invention may also be achieved by the following means.

That is:

(1) a heat developing means for performing heat development in a heating time of 10 seconds or less using a heat developing apparatus, including

a heating means for heating a sheet film at a heating region; and

a plurality of opposing rollers arranged so as to oppose the heating means and which press the sheet film and work with heating means to convey the sheet film,

wherein the time for increasing temperature when latent image was formed on the sheet film to the heat developing temperature is 4 seconds or less, and

wherein T2>T1, which is in a case that the temperature increase time T1 is from the temperature when the latent image was formed on the film to a predetermined temperature which is less than the heat developing temperature, and the temperature increase time T2 is from the predetermined temperature to the developing temperature, and

wherein expansion of the supporting base, due to temperature increase during the temperature increase time T1, from the temperature when latent image was formed on the film to a predetermined temperature which is less than the heat developing temperature, can be corrected to be substantially flat by the opposing rollers and subsequently, after which the heating can be conducted by the heating means in the temperature increase time T2, and

(2) the heat developing method of (1), wherein the predetermined temperature is set in accordance with the extent that creasing occurs when the sheet film is heated.

Unless otherwise specified, in the following this heat developing method will be called the heat developing method of the third embodiment.

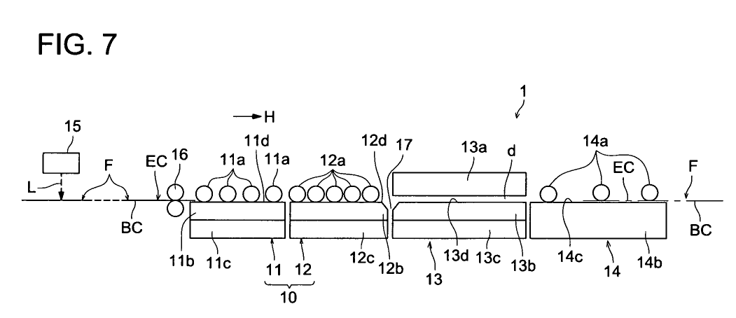

The heat developing apparatus used in the heat developing method of the third embodiment can basically use the heat developing apparatus of this invention. In the heat developing apparatus of this invention, the arrangement of the opposing rollers in the heat region, which corresponds to a temperature range from the glass transition point of the supporting substrate of the sheet film to a predetermined temperature, is different from that in other heating regions, but in the heat developing apparatus used in the heat developing method of the third embodiment, the arrangement of the opposing rollers does not have to be different from that in other heating regions. The heat developing apparatus used in the heat developing method of the third embodiment is shown in FIG. 7 for reference. The explanation for FIG. 7 is the same as that for FIG. 1 except for the part where the arrangement of the opposing rollers is different from that in other heating regions, and thus this description has been omitted.

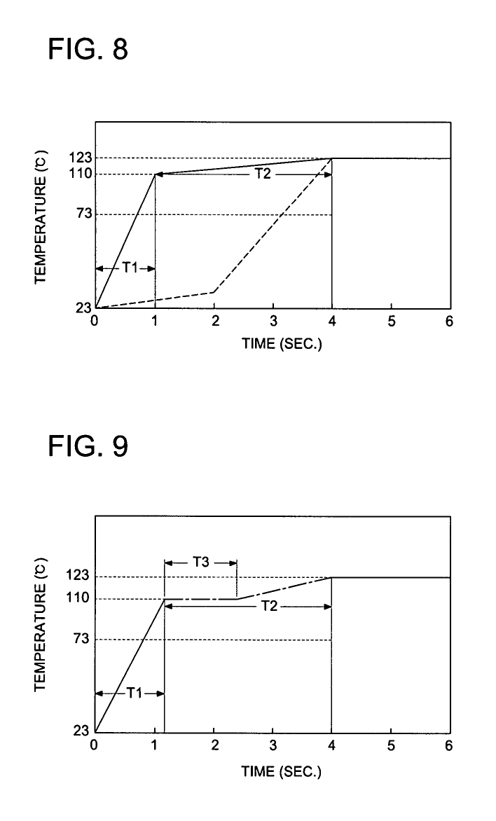

When the film is heated in comparatively short time of 4 seconds or less to the heat developing temperature for quick processing, the first heating zone 11 of the temperature raising section 10 heats the film F comparatively rapidly to increase the temperature, and the second heating zone 12 heats the film F comparatively gradually to increase the temperature, but the temperature increasing process is described more specifically in FIG. 8. FIG. 8 shows the temperature profile of the heat developing process in the heat developing method of the third embodiment used in the heat developing apparatus 1 of FIG. 7.

Latent images are formed on the EC surface by exposing the film F to laser beams L in the scanning and exposure section 15, and then in the first heating zone 11 of the temperature raising section 10, the BC surface is pressed to fixed guide surface 11d of the heating guide 11b by a plurality of opposing rollers 11a and heated while being conveyed, and the temperature is increased comparatively rapidly. That is to say, as shown in FIG. 8, temperature increase is started from room temperature (23° C. for example) at which the latent image formation occurs and the temperature is increased rapidly to a predetermined temperature (110° C. for example) that is less than the heat developing temperature (123° C. for example) in temperature increase time T1.

Next, in second heating zone 12 of the temperature raising section 10, the BC surface of the film F is pressed to fixed guide surface 12d of the heating guide 12b by a plurality of opposing rollers 12a and heated while being conveyed, and the temperature is increased comparatively gently. That is to say, temperature is increased relatively gently from the predetermined temperature (110° C. for example) to the heat developing temperature (123° C. for example) and the temperature is increased in a temperature increase time T2 which is greater than the temperature increase time T1 (T2>T1). In this manner, the predetermined temperature (110° C. for example) is increased as the point of inflection from the comparatively quick temperature increase in the first heating zone 11 to comparatively gentle temperature increase in the second heating zone 12.

Next, the film F is conveyed in a predetermined temperature retaining time (for example 6 seconds) in the gap d while the temperature is kept at the heat developing temperature (123° C. for example) in the temperature retaining section 13. Next, the film F is cooled slowly, then rapidly in the cooling section 14 and then discharged. In this manner, a film in which the latent images have been made visible can be output from the heat developing apparatus 1.

As described above, in the case where the heating time of the film is 10 seconds or less, the temperature of a film which is in a room temperature environment (23° C. for example) is increased in a short time (about 4 seconds) to the heat developing temperature (123° C. for example) and then by maintaining the film at the developing temperature for a predetermined time (6 seconds), development progresses and thus the temperature of the film is increased by approximately 100° C. in 4 seconds. In this manner, when the temperature of the film F is increased rapidly from room temperature to the predetermined temperature in the comparatively short temperature increase time T1 in the temperature range (23-110° C. for example) from a temperature greater than the glass transition point to the predetermined temperature which is within the foregoing temperature range (73-110° C. for example), creasing of the film F occurs easily. However, by pressing the entire surface of the film F in the heating region of the fixed guide surface 11d with the plurality of opposing rollers 11a in the first heating zone 11, creasing is corrected and subsequently, and then when the temperature is increased to the heat developing temperature in the relatively long temperature increase time T2, by pressing the entire surface of film F in the heating region of the fixed guide surface 12d using the plurality of opposing rollers 12a in the second heating zone 12, contact and heating is stably carried out in the comparatively long time T2 (T2>T1). In this manner, the entire surface of the film F can be uniformly heated, and thus density can be stabilized and the occurrence of density unevenness due to creasing can be suppressed.

In addition, in FIG. 8, the predetermined temperature (110° C. in FIG. 8) is set in accordance to the extent of creasing occurring when the film F is heated, and in the case where the glass transition point of the support base of PET or the like is 73° C. for example, the predetermined temperature can be set for example to 100-115° C.

It is to be noted that in FIG. 8, if the temperature increase time T1 which is from room temperature (23° C. for example) to the predetermined temperature (110° C. for example) is shorter than the temperature increase time T2 which is from the predetermined temperature (110° C. for example) to the developing temperature (123° C. for example), the temperature increase curve from room temperature to the developing temperature is not limited by that in FIG. 8. However, as shown by the broken line in FIG. 8, when the temperature increases comparatively gently to a temperature less than the predetermined temperature and then increases comparatively rapidly from the temperature less than the predetermined temperature, density unevenness due to creasing occurs easily and thus this is not preferable.

As shown above, in the case where the temperature increase time to the heat developing temperature (123° C. for example) is limited for quick processing, the temperature profile is such that the temperature range from the glass transition point of the film base (PET) to the predetermined temperature is passed in a comparatively short time, and creasing caused by expansion of the PET base occurring when this portion is passed can be corrected early to be substantially flat (stretching out the creases) with the opposing rollers and then by uniform contact heating by the heating guide along the entire film surface with the heating plate in the limited remaining time, occurrence of distortion, creasing, contact unevenness, heat transfer unevenness, and density unevenness caused by heat expansion of the film base (PET) can be suppressed, and more stable density can be obtained within a single heating time.

The expansion direction of the film that is being heated is limited by the opposing rollers and at least in their axial direction, movement is not possible due to the effect of the nip pressure, and when spring pressure acts on the left and right ends of the opposing rollers, the film tends to become convex in the center while, at the portion where the opposing rollers are not present, it tends to stretch out freely and to cause deflection. This tendency is not uniform since it is also affected by the spread direction of the PET base at the time of manufacturing of the PET base which is the support and by once again performing control using the next adjacent opposing rollers, a difference in the amount of heat transfer occurs between the portion that is in contact with the heating plate and the portion that is not in contact with the heating plate, and this causes density unevenness. In order to deal with this, the heat developing method of third embodiment, the bending of the film can be corrected and shaped so as to be substantially flat, and by carrying out the shaping early in the heating process, in the limited remaining time, the entire surface of the film can be evenly heated and more stable density can be obtained.

Next, another temperature increasing process will be described with reference to FIG. 9. FIG. 9 shows the temperature profile of the heat developing process in a separate heat developing method of the heat developing method of the third embodiment used in the heat developing apparatus of FIG. 7.

As shown in FIG. 9, in the same manner as FIG. 8, in the heating zone 11 of the temperature raising section 10, temperature increase is started from room temperature (23° C. for example) at which the latent images formation occurs and the temperature is increased rapidly to a predetermined temperature (110° C. for example) that is less than the heat developing temperature (123° C. for example) in temperature increase time T1. At this time, the entire surface of the film F is pressed and shaped in the heating region of the fixed guide surface 11d with the plurality of opposing rollers 11a in the first heating zone 11 to thereby correct the crease.

Next, in second heating zone 12, the BC surface of the film F is pressed to fixed guide surface 12d of the heating guide 12b by a plurality of opposing rollers 12a and heated while being conveyed, and the temperature is increased comparatively gently. That is to say, the temperature is gently increased from the predetermined temperature (110° C. for example) to the heat developing temperature (123° C. for example) and the temperature is increased in a temperature increase time T2 which is longer than the temperature increase time T1 (T2>T1), but as shown by the chain-dotted line in FIG. 9, after reaching the predetermined temperature (110° C. for example), the predetermined temperature is maintained for a predetermined insulation time T3 (about 1-2 seconds for example), within the time T2 and subsequently, the temperature is gently increased to the heat developing temperature (123° C. for example).

Next, the film F is conveyed in a predetermined temperature retaining time in the gap d while being temperature is kept at the heat developing temperature (123° C. for example) in the temperature retaining section 13. Next, the film F is cooled slowly then rapidly in the cooling section 14 and then discharged. In this manner, a film in which the latent images have been made visible can be output from the heat developing apparatus 1.

As is the case in FIG. 9 above, similarly in FIG. 8, even if the temperature of the film is increased, the entire surface of the film F can be uniformly heated, and thus density can be stabilized and the occurrence of density unevenness due to creasing can be suppressed.

In the heat developing apparatus of FIG. 1 and FIG. 7, after the temperature is increased to the heat developing temperature, in the temperature retaining section 13, the film is conveyed in the space d between the fixed guide surface 13d and the guide section 13a of the heating guide 13b, and even if the film is heated (heat transfer by direct contact with the fixed guide surface 13d and/or heat transfer by contact with surrounding hot air) in the gap d without being brought in close contact with the fixed guide surface 13d specifically, the film temperature is maintained within a predetermined range (0.5° C. for example) with respect to the heat developing temperature (123° C. for example). In this manner, even if the film is conveyed along the side surface of the heating guide 13b or the side surface of the guide portion 13a in the gap d, the film temperature difference is less than 0.5° C., and a uniform insulation state is maintained and thus there is little or no occurrence of unevenness in the film after process is complete. As a result, there is no need to provide driving parts (such as rollers) for the temperature retaining section 13 and a reduction in the number of parts is thereby achieved.

Furthermore, the heating time for the film F is only 10 seconds or less and thus quick heat developing process is realized, and in addition, the film conveyance path which stretches out linearly from the temperature raising section 10 to the cooling section 14 may be changed in accordance with the layout of the apparatus and adaptation to small installation area or an overall small size of the apparatus is possible.

In the large-size apparatus of the prior art, because the heat conveyance structure is the same in temperature raising section as in the portion where heat retaining function of increasing to a temperature greater than the developing temperature is sufficient, unnecessary materials are being used, and this leads to an increase in the number of parts and increased costs. Furthermore in the small-size apparatus of the prior art, it is difficult to ensure heat transfer when the temperature is increased and this is problematic in that density unevenness occurs and it is difficult to ensure high quality images. Meanwhile, according to the present invention by performing the heat development process separately in the temperature raising section 10 and the temperature retaining section 13, all the problems are solved.

In addition, the temperature raising section 10 and the temperature retaining section 13 heat film F whose EC surface on which the heat developing photosensitive has been applied, is open to an ambient atmosphere, from the BC surface side. Accordingly when the heat developing process is carried out in quick processing of 10 seconds or less, because the EC surface side is open, the solvents (water and organic solvents and the like) included in the film F which are heated and attempt to separate at the shortest distance and thus even if the heating time (evaporation time) becomes short, the solvents are unlikely to be affected by the reduced time. Also even if there are portions where the contact between the film F and the fixed guide surfaces 11d and 12d are poor, the temperature difference between this portion and portion where contact is good can be lessened by the heat diffusion effect of the PET base of the BC surface, and as a result, density differences are unlikely to occur, and density and image quality are stable. It is to be noted that generally if consideration is given to the heat efficiency, heating from the EC surface is preferable, but if consideration is given to the fact that the heat transfer rate for the PET of the support base of the film F is 0.17 W/m ° C., and the thickness of the PET base is about 170 μm, heating from this side is preferable as there is only a slight time lag and because increase in peak can be easily offset and a greater lessening effect of the contact unevenness can be expected.

Furthermore, the solvents in the film F (water organic solvents and the like) tend to evaporate due to the high temperature while leading to the cooling section 14 from the temperature retaining section 13. However, in the cooling section 14 also, because the EC surface of the film F is open to an ambient atmosphere, the solvents (water organic solvents and the like) are not trapped and they can evaporate for a longer time and thus image quality (density) becomes more stable. In this manner, at the time of quick processing, the cooling time cannot be disregarded and quick processing with a heating time of 10 seconds or less is particularly effective.

### WORKING EXAMPLES

Next, the present invention will be described more specifically using working examples, but the present invention is not to be limited by these working examples. In Working Examples 1-3, the pitch of the opposing rollers arranged on the plurality of heating plates which heat the film is changed and the crease prevention effect is checked.

In Working Example 4, the opposing rollers arranged on the heating plates which heat the film are arranged so as to incline in the film conveyance direction and the crease prevention effect is checked.

The films used in the experiments are organic solvent based heat developing films such as that disclosed in Unexamined Japanese Patent Application Publication No. 2004-102263, and SD-P manufactured by Konica Minolta was used. It is to be noted that the support of the film is PET, but as shown in FIG. 4, the coefficient of linear expansion for PET differs depending on the position of base original roll at the time of manufacture, but the films used in the experiments are films using PET that are all sampled from the same position. The glass transition point of this PET is approximately 73° C.

### Working Examples 1-3

All the heating plates have a plate configuration in a silicone rubber heater is adhered to the back surface of an aluminum plate having a thickness of 10 mm. A silicone rubber roller having a diameter of 12 mm and an effective conveyance length of 380 mm and a silicone rubber layer having a thickness of 1 mm is arranged on the guide surface of each of the heating plates. The film is pressed with a linear pressure of approximately 8 gf/cm (approximately 78.5 mN/cm) using the silicone rubber roller, and the film is conveyed while the BC (support) surface is in contact with the heating plate.

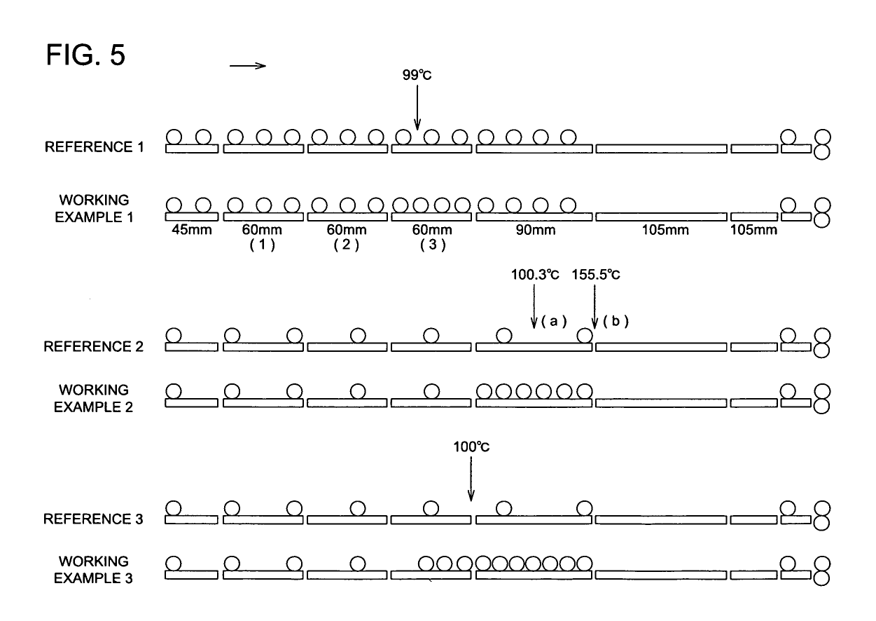

The conveyance length of each heating plate is 45 mm, 60 mm, 60 mm, 60 mm, 90 mm, 105 mm and 105 mm respectively from the upstream side (see Working Example 1 in FIG. 5). The temperature of each heating plate is controlled independently, and the film is heated from 70° C. with a heating speed of 15.6° C./second, and heated from room temperature (23° C.) to 123° C. in 4 seconds.

The positions of the opposing rollers arranged on the heating plates in Examples 1, 2 and 3 are shown in FIG. 5. The positions of the opposing rollers arranged on the heating plates in References 1, 2 and 3 are also shown in FIG. 5. In FIG. 5, a heat insulating material is arranged in the heating plates that do not have rollers, and the gap is heated while the gap d of FIG. 1 is 3 mm.

In Working Example 1, the arrangement pitch of the opposing rollers is 20 mm and the arrangement pitch of the opposing rollers on the heating plate (conveyance length 60 mm(3)) which cause the film temperature to be in the vicinity of 100° C. is 15 mm, and the film is conveyed at a conveyance speed 75 mm/second. The Reference 1 has the same conditions as Working Example 1 except that the arrangement pitch of all the opposing rollers is 20 mm.

In Working Example 2, the arrangement pitch of the opposing rollers is 45 mm and the arrangement pitch of the opposing rollers on the heating plate (conveyance length 90 mm) which cause the film temperature to be in the vicinity of 100° C. is 15 mm, and the film is conveyed at a conveyance speed 75 mm/second. The Reference 2 has the same conditions as Working Example 2 except that the arrangement pitch of all the opposing rollers is 45 mm.

In Working Example 3, the arrangement pitch of the opposing rollers is 45 mm and the arrangement pitch of the opposing rollers on the heating plate (conveyance length 60 mm (3), 90 mm) which cause the film temperature to be in the vicinity of 100° C. is 15 mm, and the film is conveyed at a conveyance speed 60 mm/second. The conditions in Reference 3 are the same as those of Working Example 3 except that the arrangement pitch of all the opposing rollers is 45 mm.

The films in Examples 1-3 and References 1-4 were heated under the foregoing conditions and the occurrence of creasing was observed and the results of visual evaluation confirmed that in Reference 1, small amount of creasing occurred at the arrow positions of FIG. 5 and the film temperature at that time is 99° C., and in Working Example 2, a larger degree of creasing than Reference 1 was confirmed at arrow positions (a) and (b) of FIG. 5 and the film temperature at that time was 100.3° C. at the arrow position (a) and 115.5° C. at position (b). In the Reference 3, a smaller degree of creasing than Reference 2 was confirmed at arrow position in FIG. 5 and the film temperature at that time was 100° C. while in the Working Examples 1-3 in which the opposing rollers are closely arranged in the vicinity of the position where occurrence of creasing was confirmed in the References 1-3, there was no occurrence of creasing, and there was no unevenness in transmitted heat due to creasing or in other words, there was no density unevenness.

### Working Example 4

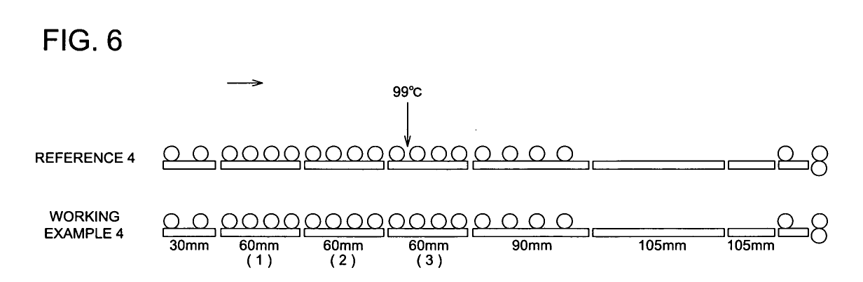

A plurality of heating plates and the opposing rollers that are arranged on the heating plates in Working Example 4 are shown in FIG. 6. Each heating plates has a plate configuration in which a silicone rubber heater is adhered to the back surface of an aluminum plate having a thickness of 10 mm. Silicone rubber rollers each having a diameter of 12 mm and an effective conveyance length of 380 mm and in which a silicone rubber layer having a thickness of 1 mm is provided on the surface layer, are arranged on the guide surface of each of the heating plates. The film is pressed with a linear pressure of approximately 8 gf/cm (approximately 78.5 mN/cm) using the silicone rubber roller, and the film is conveyed while the BC (support) surface is in contact with the heating plate.

The conveyance length of each heating plate is 30 mm, 60 mm, 60 mm, 60 mm, 90 mm, 105 mm and 105 mm respectively from the upstream side (see Working Example 4 in FIG. 6). The temperature of each heating plate is controlled independently, and heated from room temperature (23° C.) to 123° C. in 4 seconds.

In FIG. 6, a heat insulating material is arranged in the heating plates that do not have rollers and the gap is heated, while the gap d of FIG. 1 is 3 mm.

In Working Example 4, the four opposing rollers on the heating plate (conveyance length 60 mm (3)) which cause the film temperature to reach the vicinity of 100° C. are arranged by changing the direction of incline with respect to each other in the film conveyance direction (incline angle shown in FIG. 3 is 5° C.), and the film is conveyed at a conveyance speed 75 mm/second. It is to be noted that the conditions in Reference 4 are the same as those of as Working Example 4 except that the opposing rollers are not inclined as in Working Example 4.

The film was heated under the conditions given in Working Example 4 and Reference 4 and the occurrence of ceasing was observed. Visual evaluation indicated that small amount of ceasing was confirmed at the position shown by the arrow of FIG. 6. Though the temperature at that time was 99° C., there was no occurrence of ceasing in Working Example 4 in which the opposing rollers were arranged so as to incline in the vicinity of the position where occurrence of ceasing was confirmed in Reference 4. In addition, there was no unevenness in transmitted heat due to ceasing, in other words, unevenness in density.

Next, the heat developing method of the third embodiment will be described even more specifically using a referential example. The referential example confirms the effect of preventing the occurrence of creasing that occurs on the film in the case where the speed of temperature increase (temperature increase time) is changed at the inflection point (100° C.) in FIG. 8.

The films used in the experiments are organic solvent-based heat developing films such as that disclosed in Unexamined Japanese Patent Application Publication No. 2004-102263, and SD-P manufactured by Konica Minolta was used. It is to be noted that the support of the film is PET, but the coefficient of linear expansion for PET differs depending on the position of base original roll at the time of manufacture, but the films used in the experiments are films using PET that are all sampled from the same position. The glass transition point of this PET is approximately 73° C.

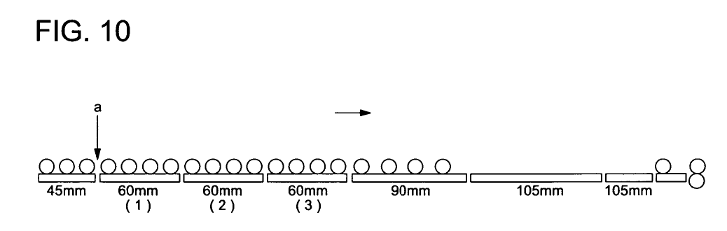

The arrangement of the heating plates of the heat developing apparatus used in the referential example is shown in FIG. 10. All the heating plates have a plate configuration in a silicone rubber heater is adhered to the back surface of an aluminum plate having a thickness of 10 mm. A silicone rubber roller having a diameter of 12 mm and an effective conveyance length of 380 mm and in which a silicone rubber layer having a thickness of 1 mm is provided on the surface layer, is arranged with an interval of 15 mm. The film is pressed with a linear pressure of approximately 8 gf/cm (approximately 78.5 mN/cm) using the silicone rubber roller, and the film is conveyed while the BC (support) surface is in contact with the heating plate.

The conveyance length of each heating plate is 45 mm, 60 mm, 60 mm, 60 mm, 90 mm, 105 mm and 105 mm respectively from the upstream side. The temperature of each heating plate is controlled independently.

In this referential example, as shown in FIG. 8, the film is heated to 100° C. in 1 second and from 100° C. to 123° C. in 3 seconds. As a result, occurrence of creasing is confirmed at position “a” of FIG. 10 (corresponding to the temperature of 100° C.-below 110° C.), but occurrence of creasing could not be confirmed at the downstream side thereof and occurrence of density unevenness caused by creasing could not be confirmed.

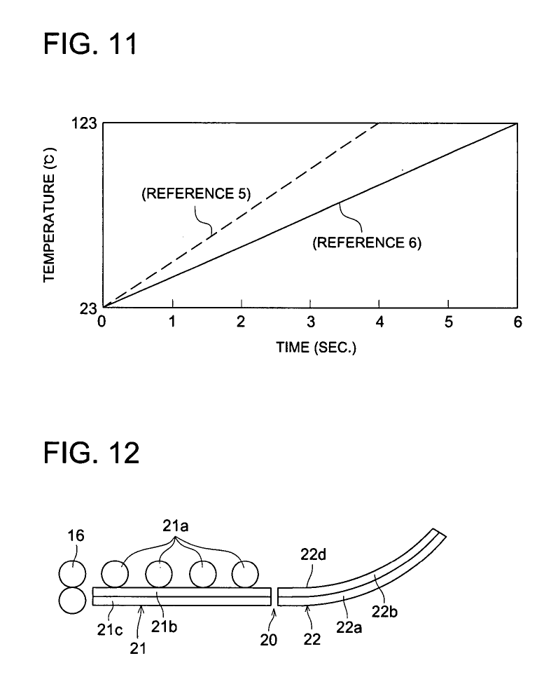

In Reference 5, as shown in FIG. 11, the temperature of the film was increased linearly from room temperature (23° C.) to 123° C. in 4 seconds. Similarly, in the Reference 6, the conveyance speed was changed and the temperature of the film was linearly increased in 6 seconds. As a result, creasing occurred in Reference 5 and density unevenness caused by creasing also occurred and creasing did not occur in Reference 6, but it was difficult to achieve high speed processing.

The preferable embodiments for realizing the present invention and working examples and reference examples were described above. However, this invention is not to be limited thereby and various modifications within the technological scope of this invention are possible. For example in the heat developing apparatus of FIG. 1, the film sheet is conveyed linearly, but this invention is not limited thereto, and as a matter of course, a structure is possible in which a guide with a curved surface is provided and the conveyance direction of the film that is conveyed on a curve may be changed. This is also the case for heat developing apparatus of FIG. 7.

In the heat developing method of the third embodiment, as shown in FIG. 12, the temperature raising section 20 which corresponds to the temperature raising section 10 in FIG. 7 includes first heating zone 21 which forms a flat conveyance path that includes a flat heating guide 21b; a flat heater 21c that is formed from a silicone rubber heater or the like; and a plurality of opposing rollers 21a which are arranged so that it is possible to press the film onto the fixed guide surface 21d of the heating guide 21b; and a second heating zone 22 forms a curved conveyance path that includes a curved heating guide 22b; a curved heater 22c that is formed from a silicone rubber heater or the like. Similarly in FIG. 8 and FIG. 9, in the first heating zone 21, the temperature of the film is increased comparatively rapidly from room temperature to a predetermined temperature (110° C. for example) that is less than the heat developing temperature (123° C. for example), and then in the second heating zone 22, the temperature is increased comparatively gently to the heat developing temperature (123° C. for example). In the second heating zone 22, the film is conveyed along the curved fixed guide surface 22d of the heating guide 22b, but the degree of temperature increase is comparatively gentle and so occurrence of sudden heat expansion is unlikely and the opposing rollers for crease correction is not included. Thus, by causing the curved fixed guide surface 22d of the heating guide 22b to have a curvature (for example R100-150 mm), it becomes possible the BC surface to be brought in uniform contact with the curved fixed guide surface 22d due to the effect of gravity, the guide surface resistance (frictional resistance) and reduction in firmness of the film itself (flexible state). In addition, the curvature has the effect of reducing the projection area (installation area) of the temperature raising section, and this contributes to improvement of degree of freedom in designing the overall structure of the apparatus. It is to be noted that in FIG. 12, there is a temperature retaining section of the slit development at the downstream side of the second heating zone 22, and this temperature retaining section may also be formed with suitable curvature.

In addition, in the working examples and the reference example, when the film is being prepared, organic solution based solvents are used, but water-based solvents may also be used. The heat developing film which uses a water based solvent is prepared in the following manner.

A coating solution in which the water content of the solvent in the layer containing the organic silver salt is 30 mass % or more, is used to coat a PET film, and it is dried to form a heat developing photosensitive layer with a thickness of 200 μm. The binder in the layer containing the organic silver salt is one which is soluble or dispersible in a water-based solvent (aqueous solvent) and is formed from a latex polymer in which the equilibrium water content at 25° C. and 60% RH is 2 weight % or less. The water based solvent in which this polymer is soluble or dispersible is water or a mixture in which 70 weight % or less of an organic solvent which can be admixed with water is added to water. Examples of the organic solvent that can be admixed with water include, alcohols such as methyl alcohol, ethyl alcohol, propyl alcohol; cellusolves such as methyl cellusolve, ethyl cellusolve and butyl cellusolve, and ethyl acetate, dimethylformamide.

More specifically, an emulsion layer (photosensitive layer) coating solution of is prepared in the following manner. 100 g of a fatty acid silver dispersion, pigment in 276 ml of water (dispersant), an organic polyhalogenated compound (first dispersant), an organic polyhalogenated compound (second dispersant), a phthalazine compound (solution), SBR latex (Tg:17° C.) solution, a reducing agent (first dispersant), a reducing agent (second dispersant), a hydrogen bonding compound (dispersant), an accelerator (first dispersant), an accelerator (second dispersant), a color regulator (dispersant), a mercapto compound (first aqueous solution), and a mercapto compound (second aqueous solution) are all sequentially added, and immediately before coating, a silver halide emulsion is added and the well mixed emulsion layer coating solution fed as it is to a coating die to perform coating.

1. A heat developing apparatus, comprising:
a heating means for heating a sheet film at a predetermined heating region after latent image has been formed on the sheet film where a heat developing photosensitive material was applied to one side of a supporting substrate; and
a plurality of opposing rollers, arranged so as to oppose the heating means, which press the sheet film and work with heating means to convey the sheet film, wherein a heating time of the sheet film by the heating means is 10 seconds or less;
wherein the arrangement of the opposing rollers in the heating region which corresponds to a temperature range from the glass transition point of the supporting substrate of the sheet film to a predetermined temperature is different from that in other heating regions.

2. The heat developing apparatus of claim 1, wherein the arrangement of the opposing rollers in the heating region which corresponds to the temperature range from the glass transition point of the supporting substrate of the sheet film to the predetermined temperature is closer than that in the other heating regions in the conveyance direction of the sheet film.

3. The heat developing apparatus of claim 2, wherein the closely arranged opposing rollers have a predetermined gap with respect to the heating means.

4. The heat developing apparatus of claim 2 or claim 3, wherein the closely arranged opposing rollers are straight rollers having the constant diameter over a total length in the axial direction.

5. The heat developing apparatus of claim 1, wherein the opposing rollers in the heating region which corresponds to a temperature range from the glass transition point of the supporting substrate of the sheet film to the predetermined temperature are arranged so as to be inclined at a predetermined angle in the conveyance direction of the sheet film.

6. The heat developing apparatus of claim 5, wherein the incline direction of the opposing rollers in the heating region is different with respect to the opposing rollers of an adjacent upstream side and/or an adjacent downstream side.

7. The heat developing apparatus of any one of claim 1 to claim 6, wherein the heating means comprises a temperature raising section for increasing the temperature of the sheet film to the heat developing temperature and a temperature retaining section for maintaining the temperature of the sheet film whose temperature was increased to the heat developing temperature.

8. The heat developing apparatus of any one of claim 1 to claim 7, wherein the heating time for the sheet film in the temperature raising section is 4 seconds or less.

9. The heat developing apparatus of any one of claim 1 to claim 8, wherein the opposing roller, that is arranged at least just before the opposing rollers which have a different arrangement from arrangement of other heating regions, has a configuration in which a diameter of a center portion in the axial direction is grater than that of the end portions.

10. A heat developing method comprises the steps of:
forming a latent image on a sheet film where a heat developing photosensitive material was applied to one side of a supporting substrate,
conveying the sheet film which carries the formed latent image, in a predetermined heating region, while pressing the sheet film using a plurality of opposing rollers arranged in a heating region, and heating the sheet film such that the heating time for the sheet film is 10 seconds or less; and
heating the sheet film in a temperature range from the glass transition point of a supporting substrate of the sheet film to a predetermined temperature, in a heating region in which the arrangement of the opposing rollers in the conveyance direction of the sheet film is different from that in other heating regions.

11. The heat developing method of claim 10, wherein when the sheet film is conveyed, heating is conducted in a temperature range from the glass transition point of the supporting substrate of the sheet film to a predetermined temperature in a heating region in which the opposing rollers in the heating region which corresponds to a temperature range from the glass transition point of the supporting substrate of the sheet film to the predetermined temperature are arranged to be closer in the conveyance direction of the sheet film than that in the other heating regions.

12. The heat developing method of claim 10, wherein when the sheet film is conveyed, heating is conducted in a temperature range from the glass transition point of the supporting substrate of the sheet film to the predetermined temperature in a heating region in which the opposing rollers are arranged to be inclined at a predetermined angle with respect to the conveyance direction of the sheet film.

13. The heat developing method of any of claim 10 to claim 12, wherein heating of the sheet film is performed in a temperature raising step for increasing the temperature of the sheet film to the heat developing temperature and a temperature retaining step for maintaining the temperature of the sheet film whose temperature was increased to the heat developing temperature.

14. The heat developing method of any of claim 10 to claim 13, wherein the heating time for the sheet film in the temperature raising step is 4 second or less.
